(19) United States
(12) Patent Application Publication
(10) Pub. No.: US 2018/0001506 A1
(43) Pub. Date: Jan. 4, 2018

(54) ROTARY CUTTING DIE FOR CUTTING CORRUGATED BOARD HAVING A REINFORCEMENT MEMBER FOR REINFORCING AND STABILIZING A CUTTING OR SCORING RULE DISPOSED ADJACENT A PRODUCT EJECTOR OPENING

(71) Applicant: Container Graphics Corporation, Cary, NC (US)

(72) Inventors: James M. Smithwick, JR., New Bern, NC (US); David Charles Crawford, Lambertville, MI (US)

(73) Assignee: Container Graphics Corporation, Cary, NC (US)

(21) Appl. No.: 15/197,208

(22) Filed: Jun. 29, 2016

(51) Int. Cl. B26F 1/38; B26D 7/18; B26F 1/44

(52) U.S. Cl. CPC B26F 1/384; B26F 1/44; B26D 7/1818; B26F 2001/4463

(57) ABSTRACT

A rotary cutting die includes a curved die board having one or more product ejector openings formed therein. A compressible product ejector is disposed in the product ejector opening for engaging a die cut product and assisting in the separation of the die cut product from the rotary cutting die. Adjacent the product ejector opening is a cutting or scoring rule for cutting or scoring corrugated board. A reinforcement member is embedded into the die board between the product ejector opening and the cutting or scoring rule. The reinforcement member reinforces the cutting or scoring rule, as well as the die board adjacent the reinforcement member.

### FIELD OF THE INVENTION

The present invention relates to rotary cutting dies specifically designed to cut and score corrugated board that is used in making corrugated board boxes.

### BACKGROUND

Rotary cutting dies are used to cut and score sheets of corrugated board to produce a die cut product that can be manipulated into boxes. Rotary cutting dies typically include a curved die board that is configured to mount on a die cylinder. When used, the die cylinder and die board are mounted adjacent an anvil and a nip is defined between the die cylinder and the anvil. Sheets of corrugated board are fed into and through the nip and, in the process, the sheet of corrugated board is cut and scored to form the die cut product. Die boards commonly include product and scrap cutting blades, scoring rules, trim and scrap strippers and product ejectors for separating the die cut product from the cutting die.

A common problem with rotary cutting dies that operate on corrugated board is that of controlling the pressure exerted against the corrugated board by the product ejectors. If the pressure is too great, the die cut product is damaged. That is, if the pressure is too great, the flutes are crushed. This makes the resulting boxes weaker and hence the boxes possess less stacking strength and the crushed flutes have a negative impact on the appearance of the product.

On the other hand, if the pressure exerted by the product ejectors is too low, then this will impact the separation of the die cut product from the cutting die during the die cutting operation. That is, if the pressure is insufficient to dislodge or remove the cut die product from the cutting die, it follows that the product will continue with the cutting die and the die cutting operation will be seriously impacted.

One approach to solving flute crushing entails seating or disposing product ejectors into openings formed in the die board. These openings can be relatively shallow or relatively deep. Typically, one or more cutting or scoring rule are seated in the die board relatively close to the product ejector opening. This means that there is only a small amount of die board area disposed between the product ejector opening and the rule or rules. Over time the rules repeatedly impact and dig into the adjacent anvil as they pass through the nip of the rotary die cutter. For example, it is not uncommon for the cutting and scoring rules to pass through the nip two or three times per second. These repeated impacts can easily damage the rule disposed adjacent the product ejector opening. The problem is that there is sometimes not enough die board area surrounding the rule to provide adequate support over time. The rules tend to bend and the bending often results in the die board cracking or being severely damaged in and around the rules and the product ejector openings.

Therefore, there is a need for a die board design that addresses the stability of a cutting and scoring rule supported in the die board adjacent such openings.

### SUMMARY OF THE INVENTION

The present invention relates to a rotary cutting die comprising a curved die board that includes cutting or scoring rules for cutting and scoring corrugated board formed into die cut products. The die board is provided with multiple product ejector openings formed therein and product ejectors are seated or disposed in the openings for engaging the die cut product and assisting in the separation of the die cut product from the rotary cutting die. In some cases, the cutting or scoring rules are disposed relatively close to the product ejector openings. In order to stabilize the cutting or scoring rules in the die board, the die board is provided with a reinforcement member that is secured in the die board between the product ejector opening and the cutting or scoring rule. These reinforcement members tend to stabilize and reinforce the cutting or scoring rules.

In an alternative design, a compression member is embedded in the die board an either side of the cutting or scoring rule. In one embodiment, the cutting or scoring rule lies between the product ejector opening and the compression member. The compression member compresses the die board and the cutting or scoring rule between the reinforcement member and the compression member. This also tends to protect the cutting or scoring rule, as well as the die board lying between the compression member and the reinforcing member.

Other objects and advantages of the present invention will become apparent and obvious from a study of the following description and the accompanying drawings which are merely illustrative of such invention.

### BRIEF DESCRIPTION OF THE DRAWINGS

FIG. 1 is a perspective view of a rotary cutting die machine including a rotary cutting die mounted on a die cylinder and an anvil disposed adjacent the cylinder.

FIG. 2 is a fragmentary plan view of a portion of a die board showing a cutting or scoring rule mounted adjacent a product ejector opening.

FIG. 3 is a sectional view taken through the line III-III of FIG. 2.

FIG. 4 is a fragmentary plan view of a die board showing an alternative design for reinforcing a cutting or scoring rule mounted in the die board.

FIG. 5 is a sectional view taken through the line IV-IV of FIG. 4.

FIG. 6 is a fragmentary plan view of a die board showing an alternative design for reinforcing a cutting or scoring rule mounted in the die board.

FIG. 7 is a sectional view taken through the line VII-VII of FIG. 6.

FIG. 8 is a fragmentary plan view of a die board showing multiple cutting or scoring rules and reinforcements therefor mounted in the die board.

FIG. 9 is a view of another die board showing a series of reinforcement members that form a product ejector opening in the die board.

### DESCRIPTION OF EXEMPLARY EMBODIMENTS

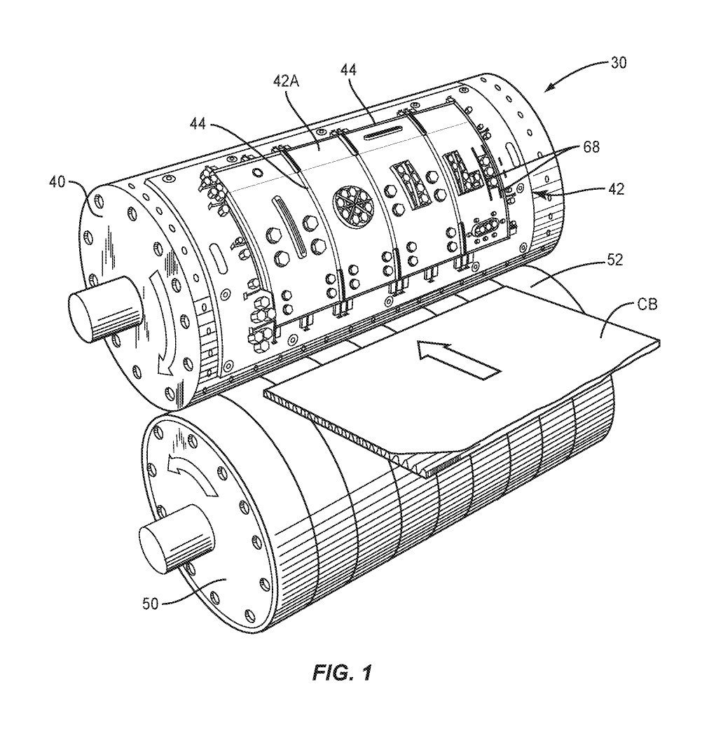

With further reference to the drawings, particularly FIG. 1, there is shown therein a rotary cutting die indicated generally by the numeral 30. The rotary cutting die 30 includes a curved die board indicated generally by the numeral 42. Die board 42 is typically manufactured of laminated wood and includes an outer surface 42A and an inner surface 42B. Die board 42 is designed to be secured to a die cylinder 40. Rotatively mounted adjacent the die cylinder 40 is an anvil cylinder 50. Anvil cylinder 50 includes an outer sheath 52 that engages various components mounted to the die board 42 as these components pass through the nip defined between the die cylinder and outer sheath 52 of the anvil.

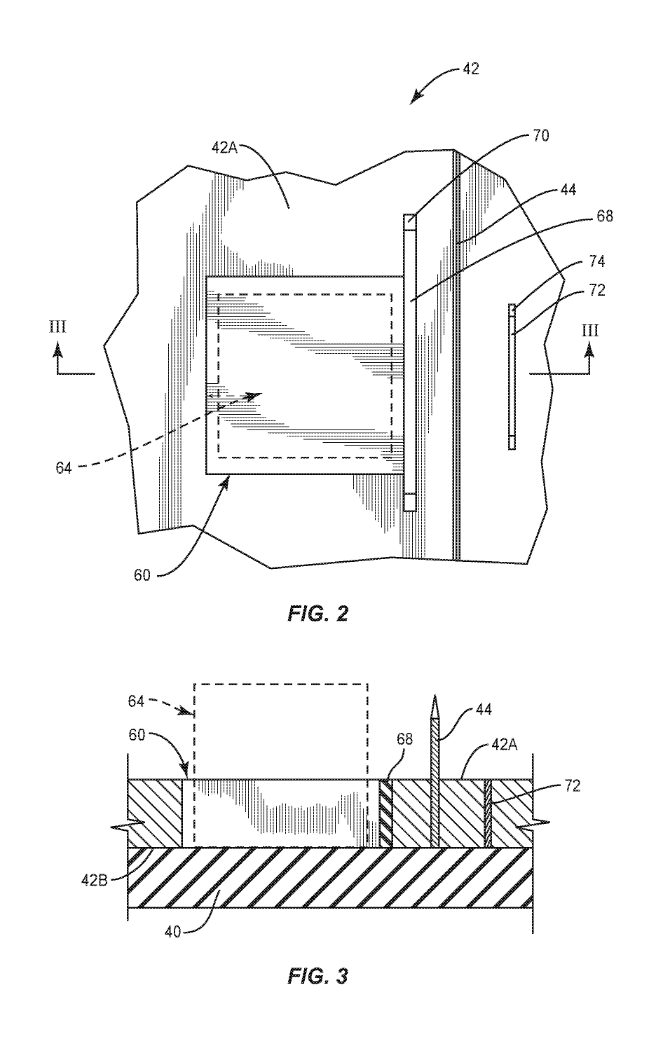

Die board 52 includes a series of product ejector openings 60. See FIGS. 2-9. At least one product ejector 64 is mounted in or disposed in the product ejector opening 60. There are various approaches to securing the product ejector 64 in the opening 60. In some cases, the product ejector 64 can be secured by glue or adhesive to the sidewalls of the opening 60. In other cases, the product ejector opening 60 includes a bottom and the product ejector 64 is glued or adhered to the bottom of the opening. In some cases, an insert can be secured in the product ejector opening and the product ejector 64 secured to the insert. In other cases, a substrate can be secured to the inner surface 42B of the die board and the product ejectors can be secured to the substrate from which they project outwardly through the product ejector openings 60 in the die board. These are just examples of ways that the product ejector 64 can be secured or disposed about the die board 42.

Rotary cutting die 30 includes various rules for cutting and scoring die cut products. In particular, there is mounted both cutting and scoring rules in the die board 42. When discussing a scoring rule, the term “scoring rule” includes perforating rules (perf rules) for perforating die cut products. Cutting or scoring rules are referred to by the numeral 44 in the drawings. While cutting and scoring rules are designed to perform different operations on corrugated board, the problem addressed by the present invention is applicable to both. Therefore, the reference to cutting rule encompasses a scoring rule and vice versa.

As seen in FIGS. 2-3, cutting or scoring rules are secured in the die board 42 closely adjacent product ejector openings 60. This means that there is a relatively small area between the product ejector opening 60 and the cutting or scoring rule 44. Rule 44 is embedded into a slot formed in the die board 42. The particular rule shown here is a cutting rule but, as noted above, it is understood that the rule could be either a cutting rule or a scoring rule. As seen in FIGS. 2 and 3, rule 44 is located near the product ejector opening 60. A slot 70 is formed adjacent the product ejector opening 60. Slot 70 extends past the product ejector opening 60 on opposite sides of one wall of the opening. A reinforcing member 68 is inserted into the slot 70. It is preferable that there be a relatively right fit between the slot 70 and the reinforcing member 68. Reinforcing member 68 may be constructed of various materials, but in one preferred embodiment, the reinforcing member is a metal reinforcing member. In some embodiments, the reinforcing member 68 may be textured, grooved or coated so as to increase the friction between the reinforcing member and the die board 42. In the case of this embodiment and the location of the slot 70, the reinforcing member 68 forms a part of the product ejector opening 60. That is, one side of the reinforcing member 68 forms a wall or side of the product ejector opening 60. It is preferable that the slot 70 be longer than the reinforcing member 68. This leaves slot 70 open on opposite ends of the reinforcing member 68. This facilitates the flexing or the bowing of the wooden die board that lies between the reinforcing member 68 and the rule 44.

In many applications, the reinforcing member 68 should be adequate to reinforce rule 44. However in some cases, it may desirable to add another member on the opposite side of the rule 44. This is also illustrated in FIGS. 2 and 3. In this regard, a slit 74 is formed in the die board on the opposite side (outboard side) of the rule 44. A compression member 72 is driven into the slit 74 and is tightly held therein. That is, the slit 74 is narrower than the compression member 72. Thus, when the compression member 72 is driven into the slit 74, the walls of the slit may slightly bow. As with the case of slot 70, slit 74 is longer than the compression member 72. This provides open areas on opposite ends of the compression member 72. Therefore, it is appreciated that the cutting or scoring rule 44 along with the die board that spans the area between the compression member 72 and the reinforcement member 68 is compressed. This compression, along with the reinforcement provided by reinforcement member 68, tends to maintain the rule 44 upright where it is tightly held in the slot provided for the rule. This reduces or minimizes the tendency of the cutting or scoring rule 44 to become loose in its slot and to wobble and tilt due to the repeated impacts with the underlying anvil 50.

In the discussion appearing above, it is noted that the reinforcing member 68 is inserted into a slot or a slit. In other embodiments, the reinforcing member 68 can be driven into the die board without there being a specific slot or slit formed to receive the reinforcing member. In addition, the reinforcing member 68 may not be planar or smooth but could assume an irregular or wavy configuration.

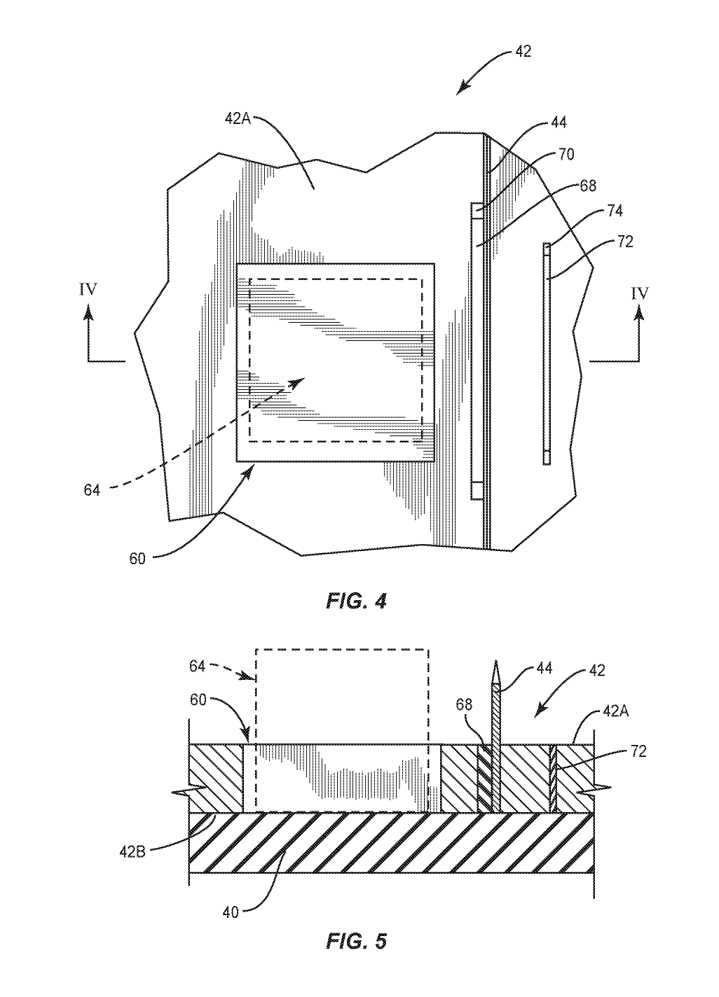

Now turning to FIGS. 4 and 5, there is shown an alternative design for reinforcing the rule 44. In this case, the reinforcing member 68 lies closely adjacent the rule 44. In one particular embodiment, the reinforcing member 68, as shown in FIGS. 4 and 5, lies immediately adjacent the rule 44. Preferably, in this embodiment the reinforcing member 68 engages the cutting or scoring rule 44. Thus, the reinforcing member 68 and the rule 44 extend in a side-by-side engaged relationship. In this embodiment, a single slot is cut in the die board 42 to accommodate the rule 44, as well as the first reinforcing member 68. However it is desirable, as discussed above, for the slot that directly accommodates the reinforcing member 68 to extend beyond the opposed terminal ends of the reinforcing member. Thus the slot is longer than the reinforcing member 68 and this provides open spaces between the opposed ends of the reinforcing member 68 and the opposed ends of the slot.

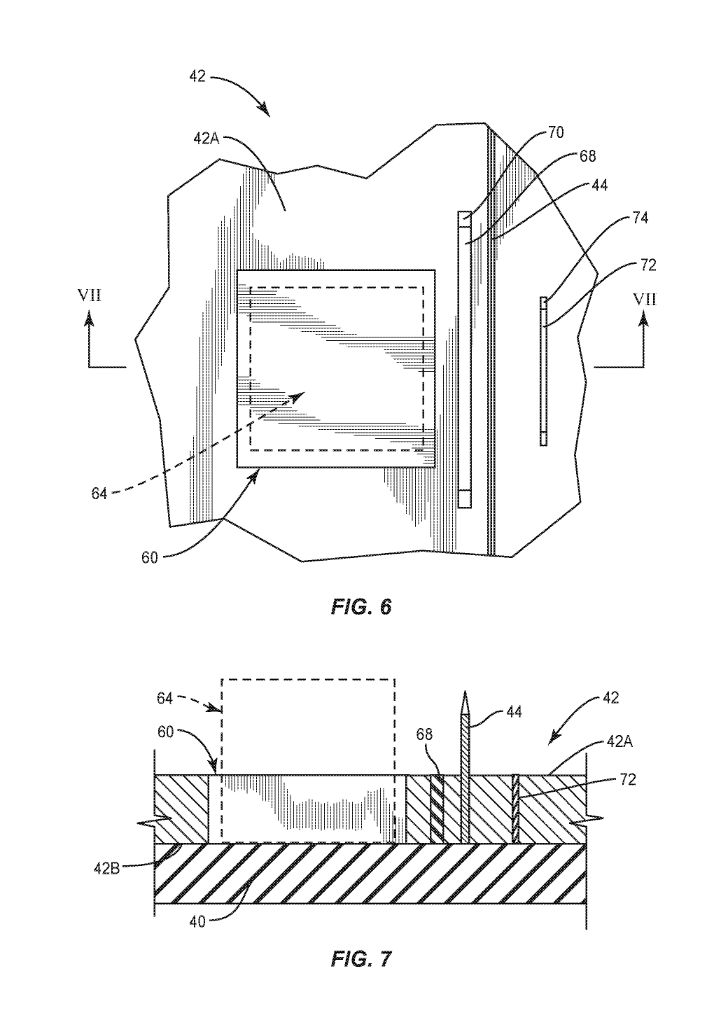

With reference to FIGS. 6 and 7, a third embodiment is shown. This embodiment is similar in many respects to the embodiments shown in FIGS. 2-5. In the case of the design illustrated in FIGS. 6 and 7, the slot 70 and reinforcing member 68 are disposed between the product ejector opening 60 and the cutting or scoring rule 44. More particularly in this case, there is a portion of the die board disposed on each side of the reinforcing member 68. As seen in the drawing, the reinforcing member 68 is disposed generally midway between the adjacent boundary of the product ejector opening 60 and the cutting or scoring rule 44. As with the other embodiments, in some applications it may be desirable to employ the compression member 72. This is shown as an option in the embodiment shown in FIGS. 6 and 7.

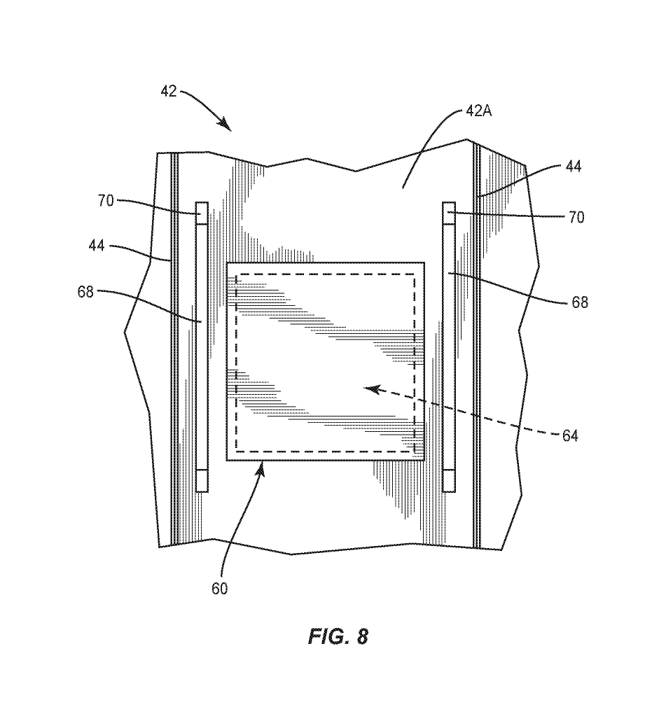

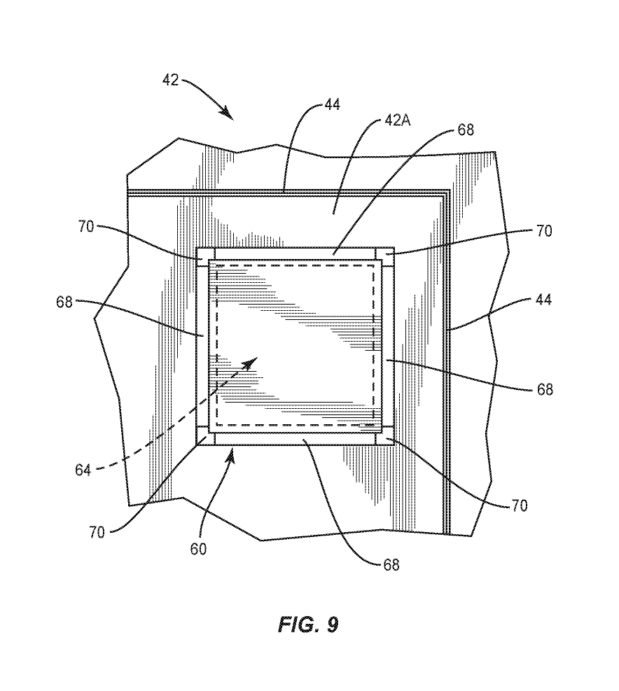

Another embodiment of the present invention is shown in FIG. 8. In this case, a pair of reinforcement members 68 are disposed in the die board 42 on opposite sides of the product ejector opening 60. As seen in FIG. 8, there is a pair of cutting or scoring rules 44 disposed on each side of the product ejector opening 60. One reinforcement member 68 is shown generally midway between each cutting or scoring rule 44 and the closest side or boundary of the product ejector opening 60. It is thus appreciated that the reinforcement member 68 reinforces the adjacent cutting or scoring rule 44.

FIG. 9 presents another embodiment of the present invention. In this case, the cutting or scoring rule 44 assumes a generally L-shape or could include multiple rules aligned to form the generally L-shaped configuration shown in FIG. 9. In any event, in this case reinforcement member or members 68 are disposed around the product ejector opening 60. More particularly, in this case the reinforcement member or members 68 form the inner wall of the product ejector opening 60. Thus, the reinforcement member of members, such as exemplified in FIG. 9, can assume a generally square or rectangular shape. The square or rectangular shaped reinforcing structure can be formed by welding or otherwise securing a series of members together. Alternatively, the generally square or rectangular shaped reinforcing structure can be bent and shaped to appropriately conform. The square or rectangular shaped reinforcement can be secured in the die board 42 in various ways. In one example, the inner walls of the reinforcement can be glued to the outer wall of the product ejector opening 60.

In the case of the embodiment shown in FIGS. 8 and 9, the option of employing the compression member 72 is not shown. However, those skilled in the art will appreciate that the slits 74 and compression member 72 can be provided at various locations in the die board shown in FIGS. 8 and 9.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. A rotary cutting die adapted to be mounted on a rotary die cylinder for cutting corrugated board fed into a nip disposed between the die cylinder and a rotating anvil to produce a die cut product, the rotary cutting die comprising:
a curved die board configured to be mounted to the cylinder and including inner and outer surfaces;
a cutting or scoring rule seated in the die board and projecting from the outer surface thereof for cutting or scoring the corrugated board fed through the nip to produce the die cut product;
a product ejector opening formed in the die board adjacent the cutting or scoring rule;
a product ejector disposed in the product ejector opening and projected outwardly therefrom past the outer surface of the die board for engaging a portion of the die cut product passing through the nip and exerting a force on the die cut product which assists in separating the die cut product from the cutting die; and
a cutting or scoring rule reinforcement member secured in the die board between the product ejector opening and the cutting or scoring rule for reinforcing and stabilizing the cutting or scoring rule and the die board adjacent the reinforcement member.

2. The rotary cutting die of claim 1 wherein the cutting or scoring rule reinforcement member assumes a curved shape.

3. The rotary cutting die of claim 1 wherein the cutting or scoring rule reinforcement member is textured, grooved or coated to increase friction between the reinforcement member and the die board.

4. The rotary cutting die of claim 1 wherein the product ejector opening includes multiple sides and wherein there is one or more cutting or scoring rule disposed adjacent multiple sides of the product ejector opening; and wherein there is provided one or more cutting or scoring rule reinforcement members disposed between multiple sides of the product ejector opening and the one or more cutting or scoring rule.

5. The rotary cutting die of claim 1 wherein the reinforcement member is secured in the die board adjacent an inboard side of the cutting or scoring rule.

6. The rotary cutting die of claim 1 wherein the cutting or scoring rule reinforcement member is secured in the die board adjacent the product ejector opening.

7. (canceled)

8. The rotary cutting die of claim 1 further including a compression member secured in the die board on one side of the cutting or scoring rule for compressing the die board between the cutting and scoring rule and the compression member.

9. The rotary cutting die of claim 8 further including a slit formed in the die board on the one side of the cutting or scoring rule and wherein the compression member is disposed in the slit.

10. (canceled)

11. The rotary cutting die of claim 8 wherein the product ejector opening, cutting or scoring rule, cutting or scoring rule reinforcement member and the compression member are all aligned.

12. The rotary cutting die of claim 1 wherein the cutting or scoring rule reinforcement member extends substantially completely around the product ejector opening.

13. A method of constructing a rotary cutting die for cutting corrugated board and forming a die cut product, comprising:
forming one or more product ejector openings in a curved die board;
disposing a compressible product ejector in the product ejector opening wherein in use the product ejector engages the die cut product and assists in the separation of the die cut product from the rotary cutting die;
securing a cutting or scoring rule in the die board adjacent the product ejector opening; and
reinforcing the cutting or scoring rule in the die board by embedding a reinforcing member in the die board at a position between the product ejector opening and the cutting or scoring rule.

14. The method of claim 13 including embedding the reinforcing member in the die board adjacent the cutting or scoring rule such that the reinforcing member engages an inboard side of the scoring or cutting rule.

15. The method of claim 13 including embedding the reinforcing member in the die board such that the reinforcing member forms a side of the product ejector opening.

16. The method of claim 13 including embedding the reinforcing member in the die board at a position approximately midway between the cutting or scoring rule and the product ejector opening.

17. The method of claim 13 further including:
forming a slit in the die board on one side of the cutting and scoring rule such that the cutting or scoring rule lies between the product ejector opening and the slit;
wherein the slit is more narrow than a compression member; and
driving and forcing the compression member into the slit and compressing the die board and the cutting or scoring rule between the reinforcing member and the compression member.

18. A rotary cutting die adapted to be mounted on a rotary die cylinder for cutting corrugated board fed into a nip disposed between the die cylinder and, a rotating anvil to produce a the cut product, the rotary cutting die comprising:
a curved die board configured to be mounted to the cylinder and including inner and outer surfaces;
a cutting or scoring rule seated in the die board and projecting from the outer surface thereof for cutting or scoring the corrugated board fed through the nip to produce the die cut product;
a product ejector opening formed in the die board adjacent the cutting or scoring rule;
a product ejector disposed in the product ejector opening and projected outwardly therefrom past the outer surface of the die board for engaging a portion of the die cut product passing through the nip and exerting a force on the die cut product which assists in separating the die cut product from the cutting die; and
a cutting or scoring rule reinforcement member secured in the die board for reinforcing and stabilizing the cutting or scoring rule and the die board adjacent the reinforcement member; and
wherein the cutting or scoring rule reinforcement member is disposed on an inner wall within said product ejector opening.
